(19) United States
(12) Patent Application Publication
(10) Pub. No.: US 2022/0118472 A1
(43) Pub. Date: Apr. 21, 2022

(54) DEVICE FOR PROVIDING ADHESIVE

(71) Applicant: Christof Schulte-Göbel, Meschede (DE)

(72) Inventor: Christof Schulte-Göbel, Meschede (DE)

(21) Appl. No.: 17/424,553

(22) PCT Filed: Jan. 21, 2020
(86) PCT No.: PCT/EP2020/051426

§ 371 Date: Jul. 21, 2021

(30) Foreign Application Priority Data
Jan. 22, 2019 (DE) 10 2019 101 539.1

(51) Int. Cl. B05C 1/08; B05D 5/10; B05D 1/28; B05C 1/00

(52) U.S. Cl. CPC B05C 1/0813; B05D 5/10; B05C 1/0817; B05C 1/003; B05D 1/28

(57) ABSTRACT

The invention relates to a device for providing adhesive without an adhesive basin, including a conveyor unit, having a first conveying device, a first inlet and a first outlet, through which an adhesive present at least in part as a solid is conveyed, and further comprising a heating unit, having a second inlet and a second outlet, and a first heating device for softening and/or liquefying the adhesive. In order to provide an efficiently and cleanly working device and a method for providing adhesive, a dosing unit having a dosing inlet, a longitudinal slit and a roller is provided.

### BACKGROUND OF THE INVENTION

The invention relates to a device and a method for providing adhesive.

EP 3 406 409 A1 describes a device and a method for providing adhesive. The adhesive is applied from a reservoir, for example by means of a spray device onto a roller, and transferred therefrom by the rotating roller to a workpiece, in this case an edge to be coated. DE 40 12 726 A1 describes a device for applying adhesive with a height-adjustable longitudinal slit from which adhesive is deposited onto a roller. EP 3 213 824 A1 describes a comparable device for applying adhesive, wherein however a scraper cleans the roller from residual adhesive after the adhesive is deposited. After being scraped, the residual adhesive is removed via a guide plate.

### SUMMARY OF THE INVENTION

It is the object of the invention to provide an efficient and smoothly working device as well as a method for providing adhesive.

The object is achieved with a device, a dosing unit and a method all as disclosed herein. The dependent claims refer to advantageous embodiments.

The device according to the invention for providing adhesive has a conveyor unit, a heating unit and a dosing unit that preferably are used in combination with each other, but that can also be each used in its own right with other, including known conveying, heating and/or dosing units.

The conveyor unit to be considered novel and inventive in its own right has a first conveying means, a first inlet and a first outlet through which an adhesive that is at least partially present as a solid is conveyed. The conveyor unit is advantageously fed with adhesive from a supply that is assigned to the first inlet. The supply can be designed as a feeding unit, for example as a conveyor belt or as a screw that is supplied for example with a finite or preferably continuously infinite supply of adhesive. Preferably, the supply is designed as a storage container from which the adhesive is removed by gravity. The conveyor unit can have a first conveying direction in which the adhesive is conveyed from the first inlet to the first outlet. The conveyor unit is generally enclosed by a housing, preferably by a tubular housing, that forms a first conveying channel which extends in the first conveying direction from the first inlet to the first outlet. The conveyor unit preferably has a length between 5 cm and 50 cm, particularly preferably between 10 cm and 25 cm. A higher conveying pressure can easily be built up in a conveying channel which can contribute to an increase in the adhesive temperature, or respectively a softening of the adhesive. The housing is preferably designed airtight and/or gas-tight so that the adhesive does not undesirably react prematurely. The first conveying means extends at least sectionally between the first inlet and the first outlet and is normally arranged in the conveying channel. It must at least convey the adhesive from the inlet to the outlet such as for example is performed by a conveyor belt. Preferably, the first conveying means applies a high conveying pressure to the adhesive. The conveying pressure is preferably between 0.1 bar and 100 bar, particularly preferably between 1 bar and 30 bar. Details on the conveying means are presented below.

The adhesive is present in a liquid or pasty form or as a solid. It can preferably be particulate, for example granulated and/or powdered, or it can also be used as a chunky solid, for example in blocks. A comminution means, for example a chopper, can be upstream from the conveyor unit.

The device according to the invention for providing adhesive has a heating unit to be considered novel and inventive in its own right with a second inlet and a second outlet, as well as a first heating means for softening and/or liquefying the adhesive. The second inlet is preferably assigned to the first outlet so that the adhesive is conveyed without loss into the heating unit and if applicable therethrough. The heating unit preferably has a second conveying direction in which the at least one partially heated adhesive moves and/or is moved from the second inlet to the second outlet. It is possible for the first conveying direction and the second conveying direction to be differently oriented directions. The heating unit advantageously has a housing in which a second conveying channel extends in the second conveying direction from the second inlet to the second outlet. The length of the heating unit is preferably between 10 cm and 50 cm, particularly preferably between 15 cm and 30 cm, generally 20 cm. The housing can preferably be designed airtight and/or gas-tight.

The first heating means can heat the adhesive directly or indirectly. For example gas, oil or electricity can be used as energy sources for heating the adhesive. Direct heating can be done by gas or oil flames that heat the housing of the heating unit. Indirect heating can be realized by the arrangement of one or more heating channels, for example for steam or thermal oil in a housing wall, or one or more heating lines, or respectively rods in the housing or on the housing of the heating unit. Preferably, one or more heating coils are used to heat the adhesive and extend between the inlet and outlet at least sectionally around the second conveying channel. As an energy carrier, for example water, gas or thermal oil is preferably used in addition to electrical power. Heating channels, heating rods, heating coils or heating lines in the housing wall or around the housing wall bring about an indirect heating of the adhesive through the inner wall of the housing as a boundary surface. According to another preferred embodiment, the first heating means is designed as an at least a two-stage heating coil, heating rod, heating channel or heating line, wherein each stage is then preferably controllable and/or regulatable, or respectively switchable. Advantageously, the processing temperature of the adhesive lies between 15° C. and 250° C. The installed heating output is then designed to heat the adhesive that passes through the heating unit to the particular processing temperature. The heating output can take into account the type of adhesive and/or the desired degree of softening. The frequently liquefied, heated adhesive with a generally reduced viscosity can preferably be conveyed by the conveying pressure applied by the first conveying means through the second inlet up to at least the second outlet

The device according to the invention for providing adhesive has a dosing unit to be considered novel and inventive in its own right with a dosing inlet, a longitudinal slit, as well as a roller. The dosing unit can be made from a material with a preferably high thermal conductivity such as aluminum, copper, or another material with corresponding properties. The dosing inlet is preferably assigned to the second outlet. The dosing unit preferably has a third conveying direction in which the heated adhesive moves and/or is moved from the dosing inlet to the longitudinal slit. It is possible for the second conveying direction and the third conveying direction to be differently oriented directions. The dosing unit is preferably enclosed by a housing that forms a third conveying channel which extends in the third conveying direction from the dosing inlet to the longitudinal slit. The adhesive exits the longitudinal slit and is advantageously deposited directly on the surface of the roller without additional tools or conveying means such as for example a means for increasing the conveying pressure, or a nozzle.

The third conveying channel can run along the shortest path between the dosing inlet and the longitudinal slit; it can, however, also be formed over a longer path in order for example to better adjust the temperature of the adhesive, or respectively the viscosity of the adhesive. The conveying channel advantageously ends in the longitudinal slit. In particular before the outlet, it can branch into the longitudinal slit in order to ensure an even distribution of the adhesive. According to an advantageous embodiment, the third conveying channel can be heated by second heating means, that will be explained in greater detail below, so that the viscosity, or respectively the temperature, of the adhesive can be adjusted directly before being applied.

The longitudinal slit is preferably elongated and preferably designed as a hole in the dosing unit. The elongated longitudinal slit preferably has a length that is greater than its width. The longitudinal slit is preferably arranged parallel to the rotational axis of the roller which will be explained below. The adhesive can preferably be deposited directly on the surface of the roller through the longitudinal slit. Advantageously, the adhesive exits over the length of the longitudinal slit in a homogeneous manner. However, viewed over the length of the longitudinal slit, more or less adhesive can, for example, exit in the middle than at the ends. This can for example be achieved by a branching in the third conveying channel that supplies the ends of the longitudinal slit or the middle of the longitudinal slit with more or with less adhesive. The amount of adhesive can, however, also be regulated for example by the particular adjusted position. The adhesive then advantageously forms a uniform unbroken adhesive layer on the surface of the roller, or a sectionally applied adhesive layer, for example applied in strips.

According to an advantageous embodiment, the length of the longitudinal slit is adjustable as will be explained below, for example in order to adapt the width of the adhesive layer that is to be deposited on the roller to the thickness of the workpiece to be coated with the adhesive.

The width of the longitudinal slit can optionally also be adjusted in a plurality of adjusted positions, preferably however at least in one narrow and in one wide adjusted position. Viewed over the length, the width of the longitudinal slit can vary. In one exemplary embodiment, the longitudinal slit can accordingly be formed in strip form with a uniform width over the entire length; in other embodiments, it can however also be formed oval, convex or biconvex, or respectively concave.

In one simple embodiment, the longitudinal slit has one opening. Alternatively, the longitudinal slit can also be composed of a plurality of openings. The design of the openings can be oval, polygonal, round or slitted. The openings can be of different size. If the longitudinal slit has a plurality of openings, this can be any desired combination of differently-shaped openings. Advantageously, the adhesive can be deposited sectionally onto the roller through a plurality of openings, i.e., in discreet sections, over the perimeter of the roller, and/or over the roller width. The distance of the roller to the longitudinal slit can preferably be between 0.1 mm and 20 mm, and particularly preferably between 0.5 mm and 5 mm.

The roller is for example an at least approximately rotationally symmetrical, preferably an at least approximately cylindrical body. Transverse to the perimeter of the preferably cylindrical roller, said roller can have a rotational axis about which it can rotate in a rotational direction along the perimeter. Adhesive is deposited on the surface of the roller from the longitudinal slit of the dosing unit. Accordingly, the longitudinal slit is advantageously oriented parallel to the rotational axis and correspondingly transverse to the roller perimeter. The preferred cylindrical roller can have at least approximately circular end surfaces at its ends spaced in the direction of the rotational axis. The roller then has a roller width that corresponds to the distance of the end surfaces. The roller is generally cylindrical; it is however also possible for the roller width to be inconsistent over the perimeter, for example when a workpiece with a variable thickness is to be coated. It is also possible for the perimeter to be variable over the roller width, for example, to apply adhesive on an unevenly shaped workpiece, for example a profiled edge that is provided with an edge strip. The distance of the roller from the longitudinal slit can be adjusted, wherein an adjusting mechanism is preferably controllable and/or regulatable by a control and regulating unit. The roller can be rotationally driven, preferably by a motor. Alternatively, the roller can however also be coupled to the drive of the device moving the work piece past the roller. In addition, the roller can be directly or indirectly heatable. The roller can have a surface that is smooth. Alternatively, the surface of the roller can also have a relief-like pattern. The roller can rotate in synchronization with the workpiece to be coated, which is preferred. However, the roller can also rotate in the opposite direction to the workpiece to be coated.

The roller is preferably constructed as follows: A guide is concentrically arranged on a central shaft that, during operation, is set in rotation by a drive, and that is mounted on the drive on one side. The guide does not rotate with the shaft. It is preferably provided with bearings, in particular with slide bearings. The roller sleeve which is also oriented concentric to the shaft is placed on the guide from the free end of the shaft. The roller sleeve abuts the slide bearings so that the easiest possible rotation is ensured during operation. If applicable, the roller sleeve can be provided with a handle that allows the roller sleeve to be easily mounted and removed. The roller sleeve is connected to the shaft in a keyed fit, or respectively lies thereupon and is also thereby set in rotation during operation. The keyed fit is for example realized by adjacent projections, or by a tongue-and-groove arrangement.

The roller, i.e., the assembly consisting of the shaft, guide and roller sleeve, possibly supplemented with the drive, is stationary according to a simple embodiment; only the roller sleeve can be removed and mounted. This embodiment is sufficient, especially when the longitudinal slit of the dosing unit can be closed by a cover. The cover can close the longitudinal slit airtight and, if necessary, light-tight. Especially in the resting position when no workpiece is being coated with adhesive, it can prevent the exit of adhesive. Since the roller sleeve is simply removed from the holder during an exchange and a new roller sleeve is mounted, a movement of the dosing unit or the roller is not needed to do this.

In the instance that workspace is desired between the longitudinal slit and roller, the roller can be moved away from the longitudinal slit. The drive and roller can be arranged so as to be movable, for example on a carriage that moves the drive and roller upward, downward or laterally away from the longitudinal slit. Preferably, the drive and roller can be tilted, pivoted or rotated relative to the longitudinal slit, for example by means of a joint or hinge that is arranged between the drive and roller on the one hand and a holder for the drive and roller on the other hand. Moreover according to another embodiment, just the roller with the guide and shaft can be pivoted or tilted, for example when the shaft is provided with a universal joint, or when the shaft is designed in two parts, and the two parts can be connected to each other in a keyed fit. Combinations of the above movements are also possible, for example a displacement of the drive and roller followed by a tilting, or pivoting, or rotation.

The roller is normally upright, or respectively vertical during operation. Even if the transfer of adhesive to the narrow surface of a workpiece occurs quickly, i.e., over a distance that is shorter than the perimeter of the roller, it cannot be ruled out that small portions of the adhesive will drip downward from the roller. In this case, it is useful to provide a catch plate at the bottom end of the roller, for example in the region of the transition between the roller and drive, that has an inner diameter which corresponds approximately to the diameter of the roller sleeve, preferably to the diameter of the guide, so that the catch plate sealingly encloses the roller sleeve, or respectively the guide. If the catch plate encloses the guide, it is therefore arranged below the roller sleeve. The outer diameter of the catch plate is greater than the inner diameter, and the catch plate is formed as a concentric trough between the inner diameter and outer diameter so that the adhesive is reliably captured below the roller sleeve. The catch plate can be designed stationary, or it can rotate with the roller. According to a further embodiment, the catch plate can have an outlet for collected adhesive, either in the manner of a notch, or as an opening. The collected adhesive can be removed in this manner.

The device according to the invention for providing adhesive has greater efficiency and greater cleanliness in the provision of adhesive, in particular because only the directly required amounts of adhesive are dispensed by the longitudinal slit onto the roller. Moreover, it makes it possible to process a broad palette of adhesives using the right kind of handling and provision options. In comparison with known versions of devices for providing adhesive in which for example an adhesive is dripped into a supply basin as a reservoir or sprayed through a nozzle, the device according to the invention for providing adhesive is distinguished by a greater degree of efficiency, especially since the adhesive is deposited on the roller after being heated without the ingress of oxygen, and also without an elevated exposure to oxygen. While being applied to a workpiece, the adhesive therefore possesses maximum reactivity and adhesive force. Moreover, by directly providing the adhesive in the absence of for example a reservoir, there is minimum loss from cleaning because a buffer is not needed that provides the heated, ready-to-process adhesive which must be discarded after stopping production. In comparison to versions that for example use spray nozzles, the device according to the invention is also distinguished by a greater uniformity in the application of the adhesive.

According to a preferred embodiment, the device according to the invention has at least one of a first, second or third closing device that is arranged between the conveying and heating unit, or respectively between the heating and dosing unit, or respectively in front of the longitudinal slit, and is controllable and/or regulatable through a connection with a control and/or regulating unit. A control and/or regulating unit explained in greater detail below can be realized by a central PLC control. This has the advantage that the exit of the adhesive from the longitudinal slit is controlled, and waste can accordingly be prevented since fresh, ready-to-process adhesive is only provided when it is needed and can be applied to an available workpiece. Moreover during, or respectively after an interruption in production, generally only the roller needs to be cleaned when the closing devices are closed since the adhesive can be provided without contacting oxygen or a second adhesive component and therefore does not react beforehand. In addition, a closing device functions as a safety apparatus. A closing device can be arranged in one of the housings of the conveyor unit, heating unit and/or dosing unit, but also separate between the individual units.

According to another preferred embodiment, the closing device is designed as a ball valve. This has the advantage of being a simple, economical and space-saving fitting that can be controlled and/or regulated with the help of a simple actuator. A closing device can how-ever also be designed as a flat slide valve, piston valve, butterfly valve, as a closable valve, as a rotatable slitted tube, or as another shut-off element.

According to another preferred embodiment, the heating unit has a second conveying means. The second conveying means can be chosen from the devices as described with respect to the first conveying means. The advantage of this is that, independent of the different applications in which adhesive must be provided with a different density in each case, the conveying pressure can be maintained or increased as needed. The second conveying means can be separately connectable. The control and/or regulating unit can for example detect the conveyed amount and the conveying pressure in situ depending on the adhesive parameters, and can change them by the second conveying means while no adaptations to the parameters then have to be made before heating the adhesive.

According to another preferred embodiment, the dosing unit has a least one second heating means. The advantage of this is that a temperature gradient from the second outlet to the longitudinal slit can be avoided. The additional heat output can be used for the fine adjustment of the temperature of the adhesive to a precise processing temperature. At the same time, it is possible to use the additional heat output as a buffer in order to quickly provide adhesive after a standstill or in order to provide greater conveyed amounts of adhesive. The second heating means can be chosen from the embodiments as described above with respect to the first heating means. The second heating means can surround the third conveying channel and for example be arranged in a meandering or spiraling manner in the dosing unit. The second heating means is moreover preferably switchable, or respectively controllable and/or regulatable separate from the first heating means by a control and regulating unit described in greater detail below.

According to another preferred embodiment, a control and/or regulating unit is provided by means of which at least the heating means are controllable and/or regulatable, wherein preferably at least one temperature sensor interacts with the control and/or regulating unit. The advantage of this is that the desired temperature for providing the adhesive can always be ensured and regulated since excessively low temperatures are associated with an excessive viscosity and therefore difficulties in application, or respectively excessive temperatures may damage the adhesive. A temperature sensor can be arranged between the conveyor unit and heating unit, between the heating unit and dosing unit, and in front of the application outlet and in the roller. Accordingly, the starting temperature of the supplied adhesive, the temperature of the heated adhesive and the temperature of the adhesive before being applied on the roller, or respectively on the workpiece can be known as parameters. The heating means are preferably switchable, and/or controllable and/or regulatable independent of each other by the control and/or regulating unit. The control and regulating unit can also be combined with a pilot control. Accordingly, the amount of adhesive can be calculated by the present conveying capacity, for example by the rotational movement of a worm conveyor, and then the necessary heat output can be generated. The signal from a temperature sensor can then be used for readjustment. Preferably, for example the conveying capacity of the conveying screw, the length and width of the longitudinal slit, the distance of the roller to the longitudinal slit of the dosing unit, as well as the position of the scraper can also be changed by the control and/or regulating unit.

According to another preferred embodiment, the dosing unit has a means for the longitudinal adjustment of the longitudinal slit. The advantage of this is that the dimension of the adhesive layer applied to the roller (the width of the adhesive layer) can be adapted to the dimension of the workpiece. If the longitudinal slit with at least one opening ends at the surface of the dosing unit, for example a pin, a bolt or a similar element can then be introduced into this opening in an adjustable, generally movable manner. This element can therefore partially or completely cover the longitudinal slit from the inside. An analogous sliding mechanism can however also be arranged such that the longitudinal slit, or respectively its openings, are covered from the outside. Another alternative is for example the arrangement of cover flaps arranged on the outside of the longitudinal slit. The mechanism for the longitudinal adjustment can be controllable and/or regulatable and can interact with the control and/or regulating unit.

According to another preferred embodiment, the roller is assigned a means for equalizing an adhesive layer deposited on the roller, preferably between the longitudinal slit and the place at which the adhesive is transferred from the roller to the workpiece. The means for evening out the adhesive can be designed as a scraper, wiper or as a second roller onto which the adhesive is for example transferred. The advantage of this is that the adhesive layer applied from the longitudinal slit to the roller has an even thickness over the perimeter of the roller. For example, the thickness of the adhesive layer can be homogeneous over the roller width; a gradient in the thickness can however also be present. It is also possible for the adhesive to be deposited in a pattern on the roller. Preferably with the assistance of the scraper or an alternative means for evening out the adhesive, the layer thickness is however at least approximately constant at at least approximately every position in the longitudinal direction over the perimeter of the roller. In general however, any tool with sufficient rigidity that can be brought into contact with the adhesive rotating on the roller can be a means for evening out that, as of an adjustable height, does not let any adhesive pass, preferably approximately over the entire roller width, which yields an adhesive layer with a desired thickness after the barrier.

According to another preferred embodiment, the conveying means are preferably designed in each case as a screw or extruder. The advantage of this is that a continuous conveyance of a solid and/or a viscous material is possible by applying a pressure while exploiting the promotion of friction.

An alternative extruder can for example be a piston extruder, a twin screw extruder, or a planetary roller extruder. It can be advantageous to coat the surfaces of the conveying means so that, in particular at a standstill, caking, adhesions and other adhesive residues are avoided. A coating can also be correspondingly considered for other surfaces that, independent of the aggregate state, come into direct contact with the adhesive.

The device according to the invention is generally made of metal. Any material can however be used that withstands the processing conditions of the adhesive used in each case, particular the temperatures that are needed for providing the adhesive, and that is inert to the adhesive. Alternatively, for example glass, ceramic or heat-resistant plastics can be used.

According to another preferred embodiment, the device for providing adhesive is designed for processing and/or providing thermoplastic hot melt adhesive, preferably in the form of adhesive blocks or granules. All thermoplastic adhesives can be processed, in particular polyurethane (PUR). PUR possesses outstanding resistance against heat, water and solvents. Accordingly, PUR is attractive for a wide variety of applications and is superior to alternative adhesives. PUR can for example be used in the dosage forms of thermoplastic PUR (TPU) or reactive PUR (such as Purmelt), and it can also be found as a thermoset. Alternative adhesives can for example be ethylene vinyl acetate (EVA), polyamide (PA), polyolefin (PO) or glues. The device for providing adhesive can be designed so that the PUR only comes into contact with oxygen and/or moisture, for example in the form of humidity, upon leaving the longitudinal slit.

According to another preferred embodiment, the dosing unit is assigned a novel device that is not disclosed in the prior art for applying a colored substance to the edge regions viewed in the direction of rotation, i.e., adjacent to the adhesive layer. The device for applying a colored substance can be used with any dosing or application units for adhesive that are also known from the prior art. The colored substance can have pigments and/or pigment preparations, or respectively dyes; however, binders, adhesive and/or additives that for example improve adhesion to the workpiece and/or to the adhesive layer can also be added to the colored substance. The advantage of this is that the optical adaptations of the adhesive joint to the color and/or pattern of the workpiece are possible, a potential adhesive joint is correspondingly laminated, and simultaneously, the cost of expensive pigments is on the one hand minimized and, on the other hand, the properties of the provided adhesive are uninfluenced since the entire adhesive layer does not have to be colored. Moreover, the colored substance can be dirt-repellent, i.e., non-adhesive to foreign bodies, water-repellent, antibacterial or antistatic. Viewed over the length of the roller, the edge regions can preferably enclose the two ends of the applied adhesive layer. The extent of the applied substance can preferably be adjusted.

The means for applying the colored substance can for example be assigned to the dosing unit and can for example comprise a reservoir for paint, dye, pigments and/or the colored substance, a feedline and a color outlet. It is however also possible for this means to be upstream or downstream from the device for providing adhesive. The reservoir can comprise a mixing station for colors so that for example a reserve of basic colors is available, and a preferred application color is always freshly mixed. A colored substance can for example merely fulfill decorative purposes. It can however also be possible for this substance to be a colored second adhesive that does not necessarily have to be the same kind as the provided adhesive.

The method according to the invention for providing adhesive is implemented by using a device as described above, wherein an adhesive at least partially present as a solid is placed under a conveying pressure in a conveyor unit and conveyed into a heating unit in which the adhesive is softened and/or liquefied under the effect of heat, and is conveyed into a dosing unit, wherein the heated and/or liquefied adhesive exits through a longitudinal slit, and is deposited on a roller. The method according to the invention comprises all the variations of providing adhesive that are described in conjunction with the use of the above-described device for providing adhesive.

The method according to the invention for providing adhesive is distinguished over known methods in terms of a high cost efficiency and a clean and easy procedure. By avoiding adhesive basins or other buffers during provision, in particular after softening and/or liquefying by heating, a high exploitation of the adhesive potential of the adhesive is ensured, and cleaning effort is avoided. At the same time, this saves significant energy costs since for example a reserve of adhesive does not have to be kept in a liquefied state in an adhesive basin while supplying heat. The adhesive is also provided in an at least approximately oxygen-free atmosphere, which enhances the quality of the provided adhesive. Moreover, the handling of the adhesive is more sustainable than conventional methods since hardly any losses occur, and only as much adhesive is provided as is consumed since work is not done batchwise.

### BRIEF DESCRIPTION OF THE DRAWINGS

Details of the invention are explained in greater detail below using exemplary embodiments. In the figures:

FIG. 1 shows a schematic representation of an exemplary embodiment of the device according to the invention for providing adhesive in a side view;

FIG. 2 shows a schematic representation of the conveyor unit from FIG. 1 in a cross-section;

FIG. 3 shows a schematic representation of an exemplary embodiment of the heating unit in a side view;

FIG. 4 shows a schematic representation of an exemplary embodiment of the dosing unit with an assigned scraper in a section transverse to the rotational axis of the roller;

FIG. 5a shows a focused schematic representation of an exemplary embodiment of the longitudinal slit in the dosing unit;

FIG. 5b shows a schematic representation of an alternative embodiment of the longitudinal slit in a front view;

FIG. 5c shows a schematic representation of an alternative embodiment of the longitudinal adjustment of the longitudinal slit in a front view;

FIG. 6 shows a schematic front view of an exemplary embodiment of the device according to the invention for providing adhesive with a means for applying a colored substance and/or dye;

FIG. 7 shows a schematic exploded representation of a roller;

FIG. 8 shows a schematic representation of a roller with a hinge and latch;

FIG. 9 shows a schematic representation of a dosing unit with a swung-away roller.

### DETAILED DESCRIPTION

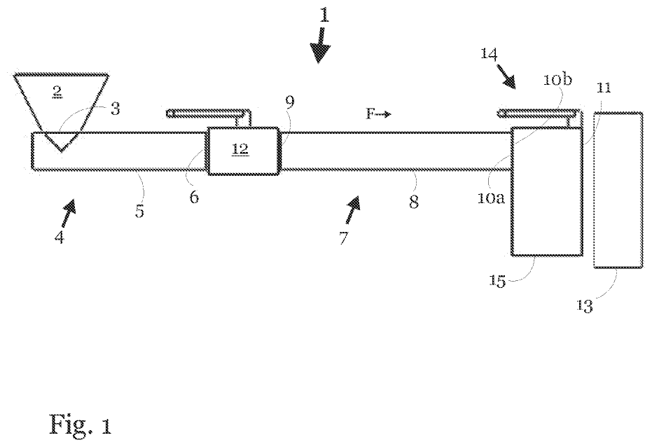

FIG. 1 shows a device for providing adhesive 1. This comprises a conveyor unit 4, a heating unit 7 and a dosing unit 14. The conveyor unit 4 is surrounded by a tubular first housing 5, the heating unit 7 is surrounded by tubular second housing 8, and the dosing unit 14 is surrounded by a block-shaped third housing 15. The tubular housings 5, 8 are made from a stainless, temperature-resistant steel that is coated on the inside with an anti-adhesive agent; the block-shaped housing 15 was made from aluminum. The housings 5, 8, 15 can as needed alternatively be made of steel, aluminum, copper, a temperature-resistant plastic, ceramic or a glass-like material. Between each of the units 4, 7 and 14, there is a ball valve 12 that, when in an open position, connects these units with each other in an air- and gas-tight matter, and that separates them from each other when in a closed position. The conveyor unit 4 is moreover assigned a funnel-shaped reservoir 2 in which a particulate PUR is located. Alternative to PUR, any other thermoplastic adhesive can also be used. The reservoir 2 is made of aluminum and does not react with the PUR. In addition, the reservoir 2 ensures a continuous supply of new PUR to the conveyor unit 4. The PUR moves downward out of the reservoir 2 under gravity through a first inlet 3 into the conveyor unit 4 where the PUR is collected by a screw conveyor and conveyed up to a first outlet 6 in the direction of the conveying direction F. The screw conveyor subjects the PUR to a conveying pressure of approximately 30 bar so that the adhesive is pressed through a ball valve 12 and through second inlet 9 into the heating unit 7. Alternatively, conveying pressures between 0.1 bar and 100 bar can be realized. In the heating unit 7, energy is supplied to the PUR in the form of heat, whereby the PUR is softened, or respectively liquefied to a viscosity suitable for provision.

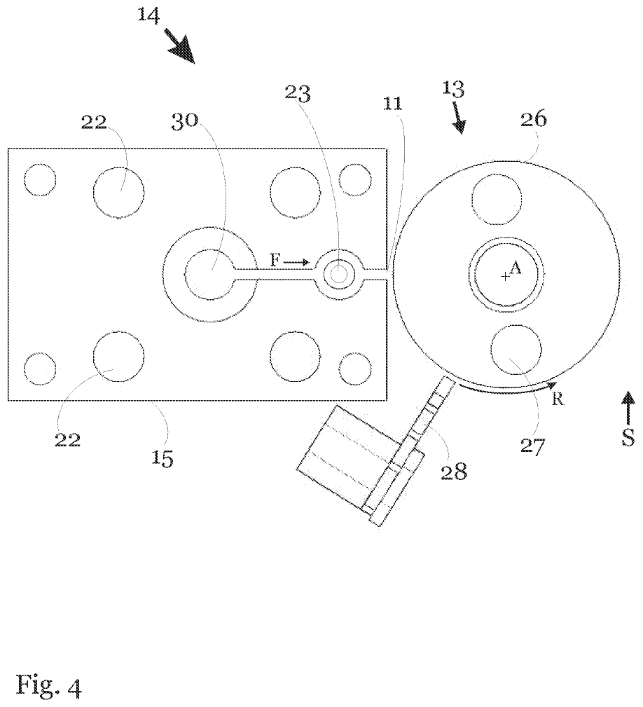

The heating unit 7 has a second conveying means (not shown here) in the interior. Accordingly, the conveying pressure can be maintained after the change of the viscosity of the PUR. The heated PUR passes through the second outlet 10a through the dosing inlet 10b into the dosing unit 14. FIG. 4 describes the properties of the dosing unit 14. The PUR is pressed up to a longitudinal slit 11, and at that location comes into contact for the first time with the atmosphere surrounding the device. The PUR is then deposited directly onto a rotating roller 13. The components of the device according to FIG. 1 are coated on the inside with an anti-adhesive and chemically highly selective agent.

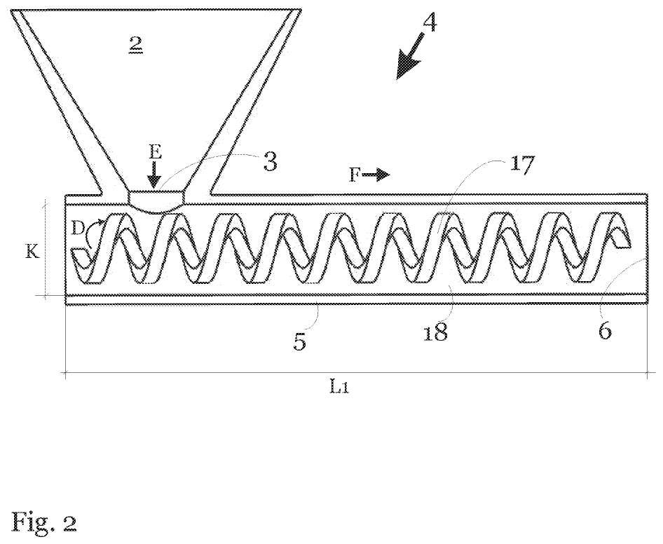

FIG. 2 shows the conveyor unit 4 of the device from FIG. 1 with the funnel-shaped reservoir 2 in a section along an axis parallel to the conveying direction. The tubular housing 5 forms a tubular first conveying channel 18 with a diameter K that is dimensioned to receive a screw conveyor 17 with a conveying capacity sufficient to move a desired conveyed amount of PUR. The conveying capacity is approximately 5 kg/h, wherein conveying capacities between 0.5 kg/h and 50 kg/h are preferably moved. The screw conveyor 17 has a rotational direction D such that the PUR is conveyed in the conveying direction F. The particulate PUR passes in the entry direction E through the first inlet 3 into the first conveying channel and is conveyed through the entire length L1 of the conveyor unit up to the first outlet 6. Alternatively, instead of a screw conveyor, an extruder can be used that is more suitable for the buildup of high conveying pressures. The conveying pressure is approximately 5 bar, wherein preferred conveying pressures lie between 0.1 bar and 50 bar, particularly preferably between 1 bar and 30 bar, and most preferably between 2 bar and 8 bar.

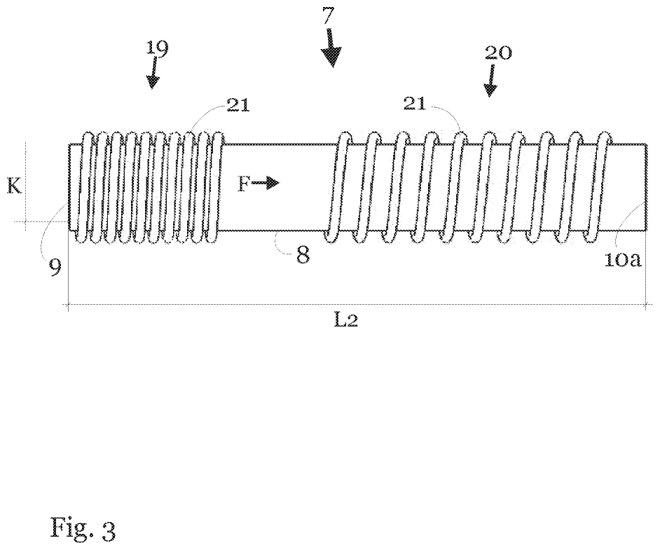

FIG. 3 shows an outside view of the heating unit 7. In the interior, the tubular housing 8 forms a second conveying channel (not shown here) with the channel diameter K and the length L2. Arranged around the housing 8 in this case are two separate heating coils 19, 20. The heating coils 19, 20 each consist of a continuous heating line 21 that is produced as a resistance wire from an iron/chromium/aluminum alloy and is electrically conductive. The heating coils 19, 20 correspondingly function as resistance heaters. The PUR is conveyed in the heating unit 7 under the conveying pressure and by the second conveying capacity of a second conveying means (not shown here) in the interior of the heating unit 7 from a second inlet 9 to a second outlet 10a along the conveying direction F. The first heating coil 19 has a tighter winding than the second heating coil 20. Accordingly, the input of thermal energy into the PUR at the beginning is locally greater. The PUR arrives in a solid and cool state; consequently a high temperature gradient promotes efficient and rapid heating. The heating coils 19, 20 are separately regulatable by a regulation unit (not shown here) so that the second heating coil 20 with the other winding can finely adjust the PUR to approximately a precise target processing temperature over a longer path and period. The heating coils 19, 20 heat the PUR up to approximately 140° C., wherein alternatively processing temperatures between 15° C. and 250° C. can be exactly generated.

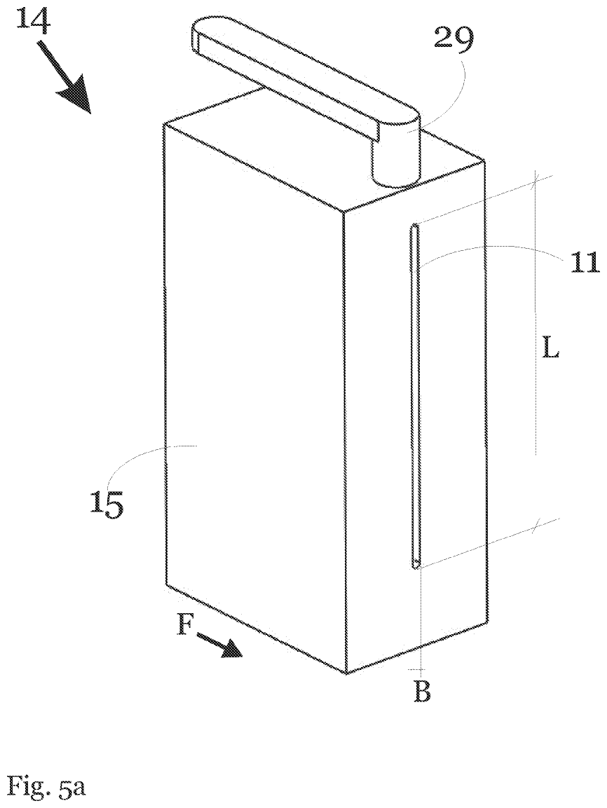

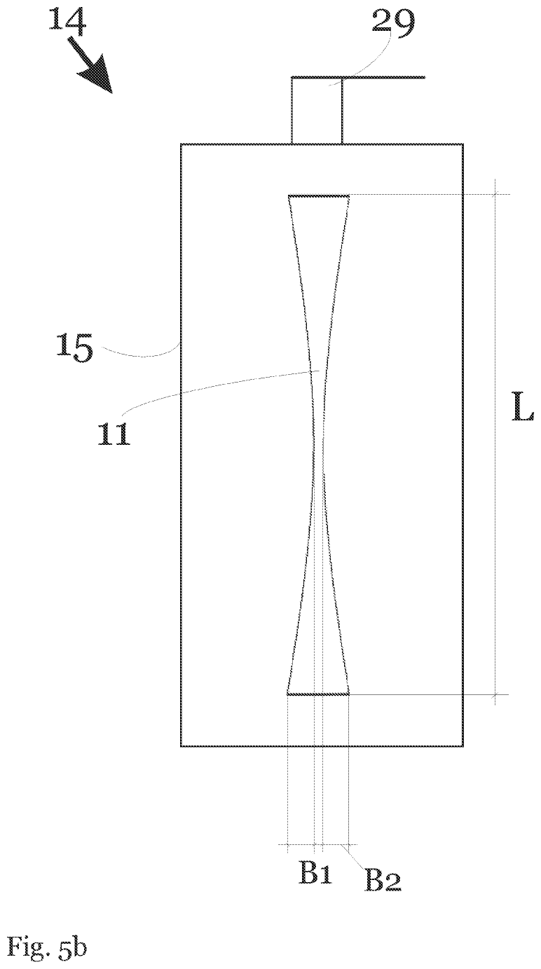

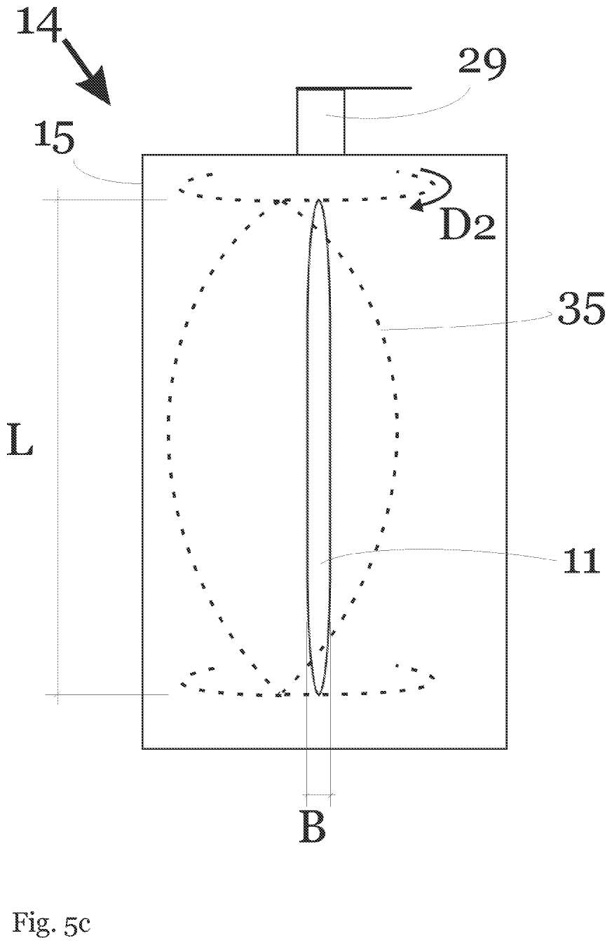

FIG. 4 shows the dosing unit 14 of the device according to the invention with an associated roller 13 on which the PUR is deposited onto the roller surface 26 from the longitudinal slit 11. The roller 13 rotates about the rotational axis A in the rotational direction R, wherein the roller 13 is driven by an electric motor (not shown here). The longitudinal slit 11 is formed in the example according to FIG. 5a as a stripped-shaped cutout in the side of the dosing unit facing the roller 13. Alternatively, FIG. 5b shows a biconcave design of the longitudinal slit so that less PUR is deposited in the middle of the longitudinal slit 11 than at the edge regions to save adhesive. In this case, the longitudinal slit has a maximum width B2 at the edge regions and a minimal width B1 in the middle. The PUR passes through the dosing inlet 10b (not shown here) into the dosing unit 14. The dosing inlet 10b in this case lies behind the image plane, just like a tubular third conveying channel that ends in the distribution chamber 30. The distribution chamber 30 is a hole in the block-like housing 15 that widens the cross-section of the third conveying channel up to that of the longitudinal slit 11. The path of the third conveying channel is meandering so that the PUR has a longer dwell time in the block-like housing 15 through which heating channels 22 run. The energy introduced by the heating channels 22 in the form of heat provides for the exact, fine adjustment of the provision temperature of the PUR that lies at about 150° C. The provision temperature should be reached by the PUR before it is finally pressed out of the longitudinal slit 11 and is deposited onto the roller surface 26.

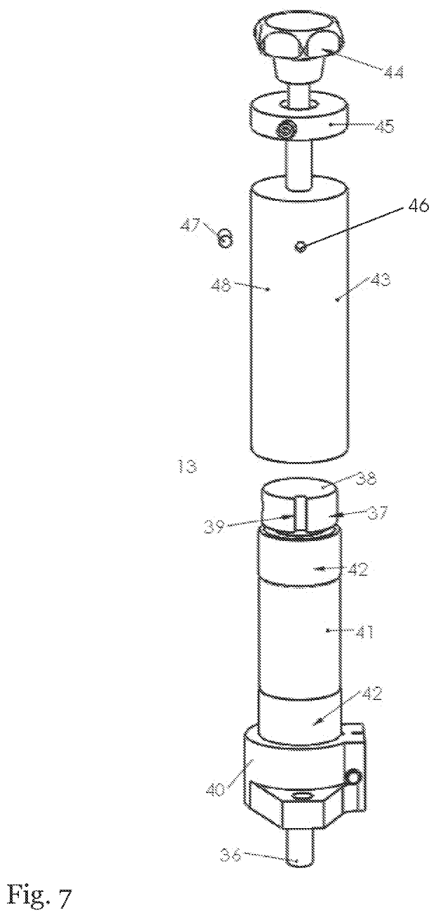

A longitudinal adjustment 23 is upstream from the longitudinal slit 11. This is a continuous hole into which an adjustment element can be introduced from one or from both sides, and accordingly the PUR can be directed to the unsealed regions of the longitudinal slit 11 instead of applying PUR to the entire thing. An adjustment element is not shown in greater detail in this case, but it can however for example be a bolt or a pin consisting of various minimally adhesive material. The roller 13 is a cylindrical body with two end surfaces spaced by the length of the roller 13. A potential design of the roller 13 is explained further in FIG. 7. The roller is made from a piece of aluminum, wherein the surface has a relief-like pattern (not shown here). The roller 13 has a roller heater 27. Thermal oil flows therethrough so that the temperature of the PUR on the roller 13 can be kept constant. In a preferred embodiment, the roller heater 27 can be realized as a heating channel, or by electrically heated heating rods. Analogously, the heating channels 22 can also be replaced by electrically heated heating rods. These ensure that the exact processing temperature of the PUR at the longitudinal slit 11 is reached. Correspondingly, the temperature of the heating channels 22 and the roller heater 27 can be regulated to a target value.

A scraper 28 assigned to the roller 13 ensures that the PUR deposited on the roller surface 26 has a homogeneous thickness viewed over the perimeter of the roller before the PUR is applied to a workpiece introduced from the thrust direction S. The scraper is made of aluminum. The material is relatively cheap, light, chemically selective and also has high strength in addition to being easily machinable.

FIG. 5a especially illustrates the design of the longitudinal slit 11. The length L of the longitudinal slit is greater by a ratio of 20:1 in comparison to its width B. Preferably, such a ratio lies between 5:1 and 100:1, particularly preferably 15:1 to 60:1. Correspondingly, the longitudinal slit 11 is always elongated, for example strip-shaped as in this case. The width B is adjustable by a control valve 29, or respectively the longitudinal slit 11 can be closed when the control valve 29 is in an end position. The control valve 29 has for example two adjusted positions so that the slit width can be discontinuously selected between narrow and wide, and the PUR flow, inter alia, can be thereby controlled. A narrow longitudinal slit 11 is easily covered by a diaphragm that is part of the maximum slit width. In alternative embodiments, a control valve 29 can be designed with continuously adjustable adjusted positions that can also control different slit widths.

In another alternative embodiment according to FIG. 5c, the control valve 29 is used to offer an alternative option for longitudinal adjustment. The adjustment is not performed by adjusting elements that can be inserted by the ends (see FIG. 4), but rather by a diaphragm 35 that can be screwed in in rotational direction D2, wherein the diaphragm 35 has a (bi)convex design. Accordingly, the longitudinal slit 11 is first covered at the edge regions, and as the diaphragm is increasingly screwed in at the end position, is also covered up to the middle from the inside. The principle can for example also be realized by a ball valve with an oval flow bore. In an alternative embodiment, the longitudinal adjustment 23 can also be designed with a concave diaphragm and can therefore cover the longitudinal slit 11 successively from the middle to the end regions upon being screwed in further.

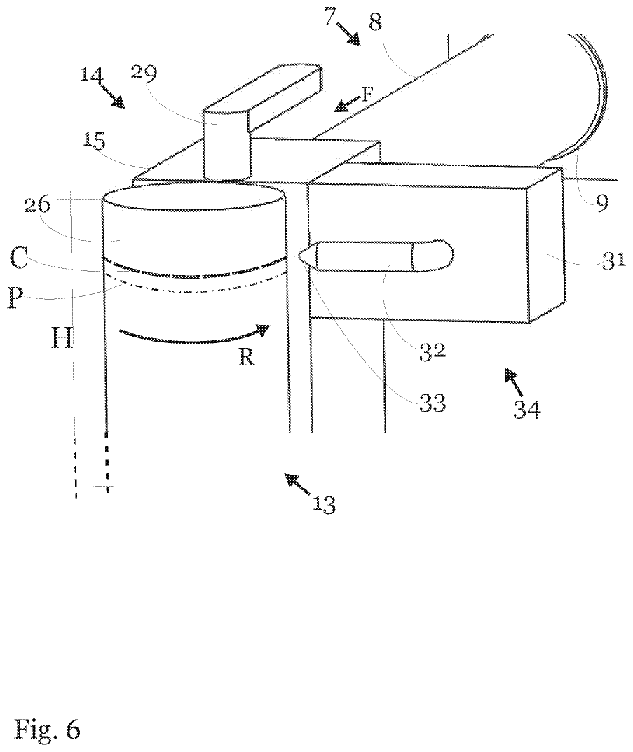

FIG. 6 shows a preferred embodiment of the device according to the invention for providing adhesive with a coloring device 34 for applying a colored substance to the roller 13. Alternatively, a binder or a second adhesive can also be applied in this manner. The coloring device 34 consists of a mixing reservoir 31, a feedline 32 and a color outlet 33. The mixing reservoir 31 contains several separate reservoirs of basic colors, and a controllable means for mixing these basic colors into a desired application color. The components of the coloring device 34 are made of aluminum and are arranged in this case so that the color can be applied directly onto the roller 13 together with the provision of the adhesive. The color application C is effected to the edge regions P of the PUR layer deposited on the roller surface 26. The resulting distance according to FIG. 6 between the color application C and the edge region P of the PUR layer is purely illustrative. In practice, contact is also possible. FIG. 6 moreover illustrates that the PUR layer can also be only over parts of the height H of the roller depending on the longitudinal adjustment of the longitudinal slit (not shown here).

FIG. 7 shows a design of the roller 13, wherein heating elements mentioned above that the roller 13 can possess are not shown for the sake of clarity. A shaft 36 extends from a drive (not shown here) to a driver 37 that is mounted on the free end 38 of the shaft 36 which is not clamped in the drive. The shaft 36, and therefore the roller 13, extend generally vertically upward since the workpiece (not shown) to be coated is guided past the side of the roller 13. The driver 37 is provided with a groove 39. The shaft 36 is enclosed by a holder 40 close to the drive. The holder 40 can be provided with a top part of a hinge (not shown here). The guide 41 that does not rotate with the shaft 36 during operation is mounted on the holder 40. The guide 41 is designed as a sleeve that is arranged concentric to the shaft 36 and encloses it. The guide 41 extends mainly from the holder 40 to the driver 37. At least one slide bearing 42 is arranged on the outside of the guide; in FIG. 7, the preferred arrangement with two slide bearings 42 is shown, wherein a first slide bearing 42 is arranged near the holder 40, and a second slide bearing 42 is attached near the free end of the 38 of shaft 36.

A roller sleeve 43 whose inner diameter is dimensioned such that the roller sleeve can be shoved over the guide 41 is also shown in FIG. 7. A handle 44 is on the roller sleeve 43 along with a bearing 45, in this case designed as a ball bearing, that can optionally be fastened to the dosing unit 14 (not shown here). To clean the device, or when changing an adhesive, or when changing the workpiece to be coated, it may be necessary to change the roller. In the present case, only the roller sleeve 43 needs to be removed and a new roller sleeve 43 mounted. The other components of the roller 13 can remain in the device. Removing the entire roller 13 is therefore avoided. It is obvious that this design is very service-friendly since only the roller sleeve 43, or respectively its outer surface needs to be cleaned without having to take into account the guide 41, or the shaft 36, or respectively the drive. More-over, only one drive, one shaft 36 and one guide 41 are needed. Only several roller sleeves 43 must be kept available, which makes this design economical and efficient to operate.

The roller sleeve 43 has an opening 46 which is penetrated by a set screw 47. The set screw 47 engages with the groove 39 during operation and causes the shaft 36 to also set the roller sleeve 43 in rotation. The outer surface 48 of the rotating roller sleeve 43 takes the adhesive from the dosing unit 14 and then transfers it within a path that is shorter than one rotation of the roller 13 to the narrow surface of the workpiece to be coated (not shown here).

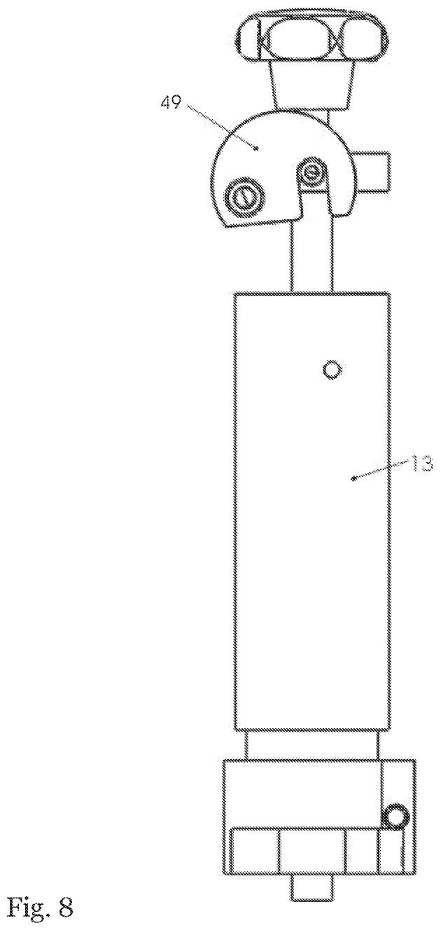

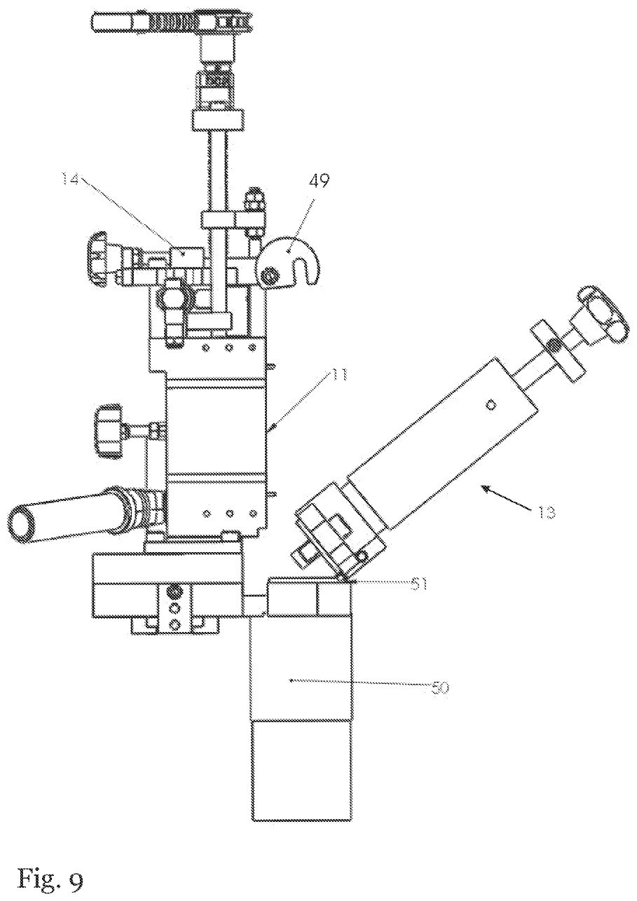

FIG. 8 shows a roller 13 according to FIG. 7 that has on its handle 44 a latch 49 attached to the dosing unit 14 (not shown here). The latch is designed as a simple hook which is placed over a projection that is attached to the handle 44 of the roller 13. FIG. 9 shows the dosing unit 14 with the roller 13 attached thereto. The drive 50 of the roller 13 is fixed to the dosing unit 14. A means, in this case designed as a hinge 51, is arranged between the drive 50 and roller 13 for swinging, or respectively pivoting the roller 13. The hinge 51 makes it possible to swing away, or respectively pivot the roller 13 relative to the dosing unit 14 when the latch 49 is opened. The longitudinal slit 11 of the dosing unit 14 is freely accessible when the roller 13 is swung away, or respectively pivoted, for example for cleaning tasks or to close the longitudinal slit 11. Alternatively, the roller 13, if applicable also with the drive 50, can also be equipped to be linearly shiftable, for example vertically shiftable. According to another embodiment, the roller 13 can also be designed for a combined movement, for example, first a shifting, and then a swinging or pivoting.

List of Reference Signs

| | |
|---|---|
| 1 | Device for providing adhesive |
| 2 | Reservoir |
| 3 | First inlet |
| 4 | Conveyor unit |
| 5 | First housing |
| 6 | First outlet |
| 7 | Heating unit |
| 8 | Second housing |
| 9 | Second inlet |
| 10a | Second outlet |
| 10b | Dosing inlet |
| 11 | Longitudinal slit |
| 12 | Ball valve |
| 13 | Roller |
| 14 | Dosing unit |
| 15 | Third housing |
| 17 | Screw conveyor |
| 18 | First conveying channel |
| 19 | First heating coil |
| 20 | Second heating coil |
| 21 | Heating line |
| 22 | Heating channel |
| 23 | Longitudinal adjustment |
| 26 | Roller surface |
| 27 | Roller heater |
| 28 | Scraper |
| 29 | Control valve |
| 30 | Distribution chamber |
| 31 | Mixing reservoir |
| 32 | Feedline |
| 33 | Color outlet |
| 34 | Coloring device |
| 35 | Screwable diaphragm |
| 36 | Shaft |
| 37 | Driver |
| 38 | Free end of the shaft |
| 39 | Groove |
| 40 | Holder |
| 41 | Guide |
| 42 | Sliding surface |
| 43 | Roller sleeve |
| 44 | Handle |
| 45 | Bearing |
| 46 | Opening |
| 47 | Set screw |
| 48 | Outer surface |
| 49 | Latch |
| 50 | Drive |
| 51 | Hinge |
| A | Rotational axis |
| B | Width |
| B1 | Minimum width |
| B2 | Maximum width |
| C | Color application |
| D | Rotational direction of a screw conveyor |
| D2 | Rotational direction of an oval diaphragm |
| E | Entry direction |
| F | Conveyance direction |
| K | Channel diameter |
| L | Length |
| L1 | Length of the conveyor unit |
| L2 | Length of the heating unit |
| P | Edge region of the PUR layer |
| R | Rotational direction |
| S | Thrust direction |

1. A device for providing adhesive (1) without an adhesive basin, comprising:
a conveyor unit (4), having a first conveying means, a first inlet (3) and a first outlet (6) through which an adhesive present at least in part as a solid is conveyed,
a heating unit (7), having a second inlet (9) and a second outlet (10a), as well as a first heating means for softening and/or liquefying the adhesive,
and a dosing unit (14) having a dosing inlet (10b), a longitudinal slit (11) as well as a roller (13), wherein the dosing unit (14) is assigned a means for applying a colored substance and/or a dye adjacent to the adhesive layer.

2. The device according to claim 1, wherein a first closing device and/or a second closing device are arranged between the conveying and heating unit (4, 7), or respectively between the heating and dosing unit (7, 14), and are each controllable and/or regulatable.

3. The device according to claim 2, wherein the closing device is designed as a ball valve (12).

4. The device according to claim 1, wherein the heating unit (7) has a second conveying means.

5. The device according to claim 1, wherein the first heating means is designed as an at least single-stage heating coil (19, 20).

6. The device according to claim 1, wherein the heating means are controllable and/or regulatable, wherein at least one temperature sensor interacts with the control and/or regulating unit.

7. The device according to claim 1, wherein the dosing unit (14) has a means for the longitudinal adjustment (23) of the longitudinal slit (11).

8. The device according to claim 1, wherein the dosing unit (14) has a means for adjusting the width of the longitudinal slit (11).

9. The device according to claim 1, wherein the dosing unit (14) has means for closing the longitudinal slit (11).

10. The device according to claim 1, wherein the roller (13) is assigned a means for evening out an adhesive layer placed on the roller.

11. The device according to claim 1, wherein the roller (13) is equipped with means (51) for swinging or pivoting.

12. The device according to claim 1, wherein the first and/or the second conveying means are designed as a screw or extruder.

13. The device according to claim 1, wherein means for processing and/or providing thermoplastic hot melt adhesive are provided, preferably in the form of polyurethane granules.

14. (canceled)

15. A method for providing adhesive by using a device according to claim 1, wherein, wherein an adhesive at least partially present as a solid is placed under a conveying pressure in a conveyor unit (4) and conveyed into a heating unit (7) in which the adhesive is softened and/or liquefied under the effect of heat, and is conveyed into a dosing unit (14), wherein the heated and/or liquefied adhesive is deposited on a roller (13) through a longitudinal slit (11), and wherein a means is provided for applying a colored substance and/or a dye adjacent to the adhesive layer.

16. A dosing unit (14) for providing adhesive, having a dosing inlet (10b), a longitudinal slit (11), as well as a roller (13).

17. (canceled)

18. The new device according to claim 13, wherein the means for processing and/or providing thermoplastic hot melt adhesive process and/or provide the thermoplastic hot melt adhesive in the form of polyurethane granules.
